(19) United States
(12) Patent Application Publication
(10) Pub. No.: US 2025/0272309 A1
(43) Pub. Date: Aug. 28, 2025

(54) METHOD AND APPARATUS FOR STORING AND DISTRIBUTING CONTENT IN A DISTRIBUTED COMPUTING ENVIRONMENT

(71) Applicant: Visional, LLC, Los Angeles, CA (US)

(72) Inventor: Daniel Marum, Los Angeles, CA (US)

(21) Appl. No.: 18/584,261

(22) Filed: Feb. 22, 2024

(51) Int. Cl. G06F 16/27; G06F 16/25

(52) U.S. Cl. CPC G06F 16/27; G06F 16/258

(57) ABSTRACT

A method, apparatus, and data structure for synchronizing data between a plurality of participant nodes in a decentralized content production pipeline network. A first participant node executes a data sharing service. The data includes metadata segments corresponding to data segments in a log-structured manner. A second participant executes a client polling service which identifies data and sends a request for a specific data segment that is stored in the repository of the first participant node. In response to the request for the specific data segment, the first participant node packs the at least one data segment into an archived format segment based on a similarity index computed across a dependency graph, where the dependency graph includes a cross-node dependency for the data segment between the first participant node and the second participant node and transfers the archived format segment from the first participant node to the second participant node.

### BACKGROUND

In the media & entertainment industry, a “production pipeline” is a chain of content creation and processing steps where the output of each step can be used as the input of the next. The content typically gets more refined and complete as it reaches the end of the pipeline. For example, a simple live action production starts with the raw footage from a shoot and ends with the final master and deliverables to be screened. The simplest form of pipeline can be an informal workflow of steps manually executed by people moving files between sites and content applications. A more advanced pipeline can be narrowly defined and tracked by information systems that manage the execution and status of each step across distributed teams of people and many creative disciplines.

Creative “workloads”, e.g., digital content, for media & entertainment productions are increasingly stored and distributed across the respective computing systems of many creative teams around the globe. This distributed paradigm is not adequately addressed in the technology used by these teams. Transferring content between production sites to collaborate on work is largely a manual process. For example, the various teams use general purpose transfer protocols to move large datasets of Ultra HD and 3D content back and forth over network connections between distributed computing systems. The high cost and fundamental speed limits of these transfers is a challenging commercial and operational friction point for distributed productions.

Current state of the art in pipeline solutions, for example Shotgrid™ and Ftrack™, follow a centralized client/server model. They use a general-purpose architecture of a relational database and web applications to implement a generic CRUD (Create, Read, Update and Delete) information service. Web browser and API clients access the system over HTTP. The database represents a centralized “source of truth” for the status of production entities such as shots and content versions. Almost all logic that tracks production steps and content metadata must be implemented by customers using client APIs. Typically, client tools query the database before a pipeline operation and update the database with results after the operation is completed. This naturally bifurcates the data, i.e., the content is stored on a central file system at each site and the content metadata is stored in the central information system. As a result of this architecture and data model, metadata query requires a remote network call.

Teams typically use Fast Adaptive and Secure Protocol (FASP) to transfer content between sites. FASP is a proprietary data transfer protocol built upon the connectionless User Datagram Protocol (UDP), a Transport Layer protocol. In such systems, new creative iterations of content generate a constant and large data transfer load. Teams must manually curate what content should be sent and when to avoid bottlenecks and costs. An up-to-date information service can answer queries that potentially help content transfer planning-but the service contains no logical working model of content management and distribution. As a result of the above, conventional systems and methods have several limitations:
the information server is a single point of failure, if it becomes unavailable all work stops for potentially thousands of users;
for globally distributed teams, the latency to a distant remote server can dominate operation time for every user and API interaction;
all operations and UX updates have the overhead of a blocking synchronous network request to a remote server adding unavoidable latency and limiting bandwidth; and the logic and data model for tracking status, dependencies, and synchronization of content data across multiple sites must be explicitly implemented using client APIs.

### SUMMARY OF THE INVENTION

The disclosed implementations provide a more decentralized and distributed production content management system and method that is more efficient than conventional distribution mechanisms. The disclosed implementations semantically analyze production content based on metadata, replicate metadata shards locally to other sites, and then exploit this data to compress and transfer only the data portions required to reconstruct requested content at destination computing systems.

A first disclosed implementation is a method for synchronizing data between a plurality of participant nodes in a decentralized content production pipeline network, the method comprising: executing, by a first participant node of the plurality of participant nodes, a data sharing service that is configured to serve data in a corresponding repository, wherein the data includes metadata segments corresponding to data segments in a log-structured manner; executing, by a second participant node of the participant nodes, a client polling service that polls the data sharing service to gather new records from a last fetched log location of the repository of the first participant node and identify and send a request for a specific data segment that is stored in the repository of the first participant node; in response to the request for the specific data segment, packing, by the first participant node, the at least one data segment into an archived format segment based on a similarity index computed across a dependency graph, where the dependency graph includes a cross-node dependency for the data segment between the first participant node and the second participant node and transferring the archived format segment from the first participant node to the second participant node.

A second disclosed implementation is a computer system for synchronizing data between a plurality of participant nodes in a decentralized content production pipeline network, the system comprising: at least one computer processor; and at least one memory operatively coupled to the at least one computer processor and storing instructions which, when executed by the at least one computer processor, cause the at least one computer processor to: execute, by a first participant node of the plurality of participant nodes, a data sharing service (vrepod) that is configured to serve data in a corresponding repository, wherein the data includes metadata segments corresponding to data segments in a log-structured manner; execute, by a second participant node of the participant nodes, a client polling service (vsyncd) that polls the data sharing service to gather new records from a last fetched log location of the repository of the first participant node and identify and send a request for a specific data segment that is stored in the repository of the first participant node; in response to the request for the specific data segment, pack, by the first participant node, the at least one data segment into an archived format segment based on a similarity index computed across a dependency graph, where the dependency graph includes a cross-node dependency for the data segment between the first participant node and the second participant node; and transfer the archived format segment from the first participant node to the second participant node.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the appended drawings various illustrative embodiments. It should be understood, however, that the invention is not limited to the precise arrangements and instrumentalities shown. In the drawings:

FIG. 1 is an architectural and data flow diagram in accordance with disclosed implementations.

FIG. 2 is a flowchart of a process for transferring only the bits required to construct a new element version at target site in accordance with disclosed implementations.

FIG. 3 is a flowchart of a process for transferring only the bits required to construct a dependent element at target site in accordance with disclosed implementations.

### DETAILED DESCRIPTION

Disclosed implementations include a novel distributed for media and entertainment production pipeline workloads. The disclosed implementations address the limitations of conventional systems noted above. Disclosed implementations manage all digital content, metadata, and configurations for a production in a file system directory referred to herein as a “repository”. Repositories can be stored as a sharded database in a non-transient computer memory device, such as a hard disk array. “Sharding” is a type of partitioning the schema is replicated across (typically) multiple instances or servers, using some kind of logic or identifier to know which instance or server to look for the data. An identifier of this kind is often called a “Shard Key”.

Disclosed implementations semantically analyze production content as metadata, replicate metadata shards locally to other sites, and then exploit this data to compress and transfer only the bits required and reconstruct content at destination sites. The semantic metadata models how content is logically related to each other. For example, a production step such as compositing loads camera footage and computer generated content versions to compute new a composited content version. The metadata models this data flow of inputs/compute/outputs in the dependency graph. It also models versions of content produced by iterating this production step. This semantic data is used to reconstruct the bits of content versions at a destination sites rather than transferring it.

Content, such as scene files and media content, are automatically organized into consistent folder structures inside a repository. Production metadata can be stored directly in the repository in a hidden DataStore directory named, e.g.,.vp_repo (“repo”). For every directory in the repo there is a corresponding record in the datastore to qualify and track it as a production entity. The DataStore acts as a hybrid database/virtual filesystem and can provide random, log-based, and query-based access APIs to production metadata (which in a conventional architecture would be stored in a central relational database). However, the DataStore abstracts the underlying file system structures of directories and files to represent production structures such as sequences, shots, content elements and their versions. For every directory in the repo there is a corresponding record in the datastore to qualify and track it as a production entity.

An “element” is a named and typed class of production content. The name of an element should be globally unique within a repository. The content payload of an element is stored in an “element version.” For example, an element can be a clip of footage, a 3D model or a compound element containing multiple types of content. Elements are immutable. Each new creative iteration of an element is stored in a new element version. A repository doesn't require a network connection to a central server in order to store elements.

Every production directory at every site is a full-fledged repository with complete history and full production tracking abilities. All production operations are local and fast. In order to accomplish this, each repository includes a computed content hash for each file of each new element version and stores the hash values in the DataStore. The content hashes can be used to quickly detect which files have changed between element versions.

Dependencies between content elements are automatically detected. Each content creation and processing step is mediated by an executable type module which ensures the content is written to the desired element, type and version slot in the DataStore. Any existing element versions used as inputs to write the new version are marked/tagged as upstream nodes in a dependency graph structure in the DataStore. Disclosed implementations automatically detect the dependencies between content elements. Each content creation and processing step is mediated by a small program called a Visional Type Program. A type program ensures the content is written to the desired element, type and version slot on disk. Any existing element versions used as inputs to write the new version are marked as upstream nodes in a dependency graph structure in the DataStore. In disclosed implementations, data is reconstructed at the other end to minimize transmission by leveraging distribution of semantic metadata. A sharding paradigm is used for synchronizing information between sites.

The DataStore can be an append-only sparse three dimensional persistent hash map. In this respect, the DataStore can be similar to Bigtable™, Google's fully managed NoSQL Big Data database service.

Repositories support distributed project workflows by sharing metadata over the network. Other repositories connect and replicate the metadata to their own datastore as a separate shard copy. A distributed repository is eventually consistent using a last write wins approach (for example Cassandra, an open-source, distributed, wide-column store, NoSQL database management system. Eventual consistency is a consistency model used in distributed computing to achieve high availability that informally guarantees that, if no new updates are made to a given data item, eventually all accesses to that item will return the last updated value. Replication is achieved by a vrepod service module that serves repo data in a log-based fashion and a client vsyncd service module that polls any number of remote vrepod services to gather new records from the last fetched log location. All “modules” include executable code stored in a non-transient memory and executed by a processor.

Because replication can be asynchronous from a user and API standpoint, all operations remain simple local and immutable additions to the local repository. Connecting repositories via network services augments the DataStore structure into something closer to a Distributed Hash Table (DHT), a distributed system that provides a lookup service similar to a hash table, or a Distributed Append-only (a property of computer data storage such that new data can be appended to the storage) Log.

As noted above, a repository is a virtual file system that tracks elements, element versions, and relationships between versions. Stated differently, a repository tracks how element content changes across versions. A repository is also a highly parallel database system with random and log-based access. A repository can asynchronously replicate DataStore cells to other repositories over the network so each repo has a local shard of the remote. This nexus of properties allows for novel site to site synchronization of content.

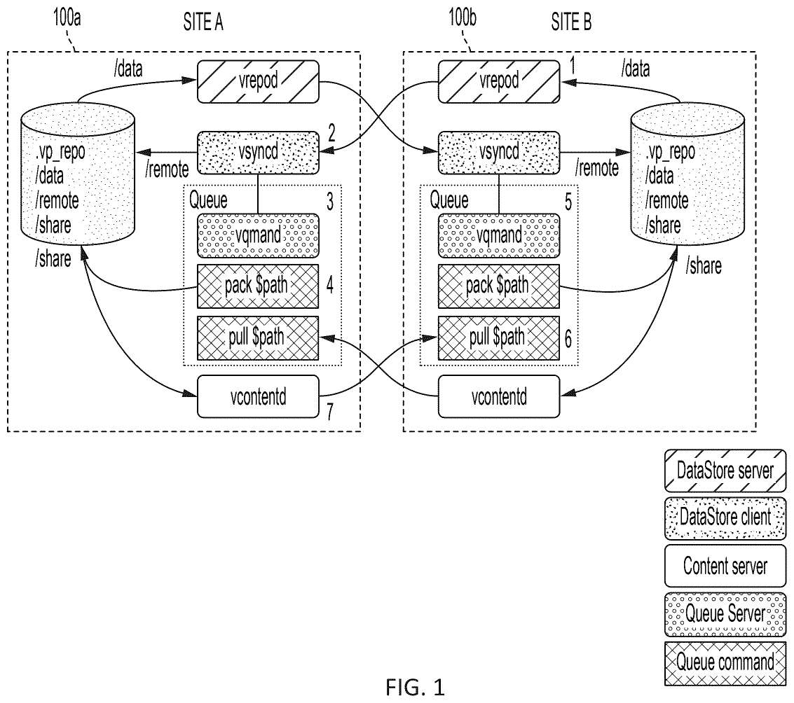

FIG. 1 illustrates a simplified computer architecture in accordance with disclosed implementations. In FIG. 1, there are only two sites (SITE A and SITE B). However, there could be any number of sites and corresponding computing systems (nodes). Typically, there would be a node for each party involved in a production, which could result in hundreds of nodes. As shown in FIG. 1, SITE A has node 100a associated therewith and SITE B has node 100b associated therewith. In FIG. 1 each of nodes 100a and 100b has similar elements denoted respectively by an “a” or “b” suffix. The nodes can be computing systems as described below. For brevity of description, these elements are sometimes discussed together without reference to the suffix. DataStore 102 can be the DataStore described above.

As shown in FIG. 1, each node includes a vrepod module which executes a service to share the local datastore (over TCP for example), as shown at 1. Each node also includes a vsyncd module which runs a service to poll, and execute get commands and store commands to and from remote datastores (i.e., datastores on other nodes) as shown at 2. The vsyncd module handles remote packing of records and queuing, through a vqmand module as shown at 3. At 4, pack $path command is executed to compress and archive data as a share. At 5, the vsyncd of a remote node (node 100b in this example) remotely pulls the requested record. At 6, node 100b executes pull $path is executed to request and pull the archived share. At 7, node 100a executes a vcontentid module to serve the archived share (over http for example).

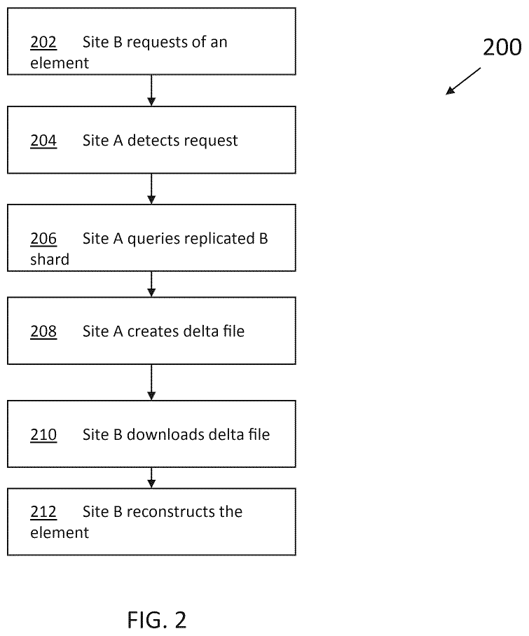

FIG. 2 illustrates an example of process 200 for transferring only the bits required to construct a new element version at target site using the architecture of FIG. 1. At 202, Site B requests a sync of element render_v002 content from Site A. At 204, Site A detects this sync request in its replicated B shard. At 206, Site A queries its replicated B shard and detects B already has already has elements that are inputs to render_v002 in the dependency graph. At 208, Site A computes a similarly index to determine which input is most similar to render_v002 and Site A encodes the difference between render_v001 and render_v002 into a delta file in the share directory of the repository. At 210 Site B detects the delta file is ready in its' replicated shard of site A and Site B downloads the delta file from site A content server (using any appropriate transport protocol). At 212, Site B reconstructs render_v002 by decoding render_v001 into render_v002 using the delta file.

Process 200 leverages the fact that many element versions of visual data are incremental iterations where the perceptual change may seem noticeable but the data change is small and encodable. Many tests show a compression ratio in the range of 1024 (space saving of 99%). Accordingly, a conventional system would send, for example, 355 Megabytes while the disclosed implementations would only have to send 345 Kilobytes to reconstruct the same data at the destination. This reduces computing resources tremendously and thus increases the speed of operation of the system significantly.

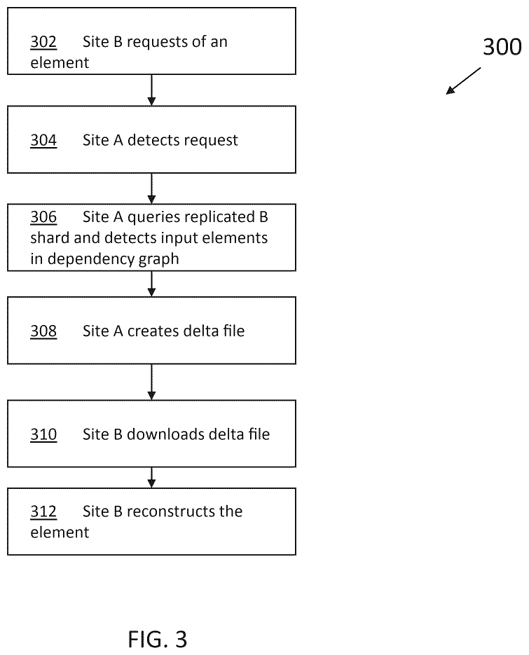

FIG. 3 illustrates process 300 for transferring only the bits required to construct a dependent element at target site. At 302, Site B requests a sync of element render_v002 content from Site A. At 304, Site A detects this sync request in its replicated B shard. At 306, Site A queries its replicated B shard and detects B already has already has elements that are inputs to render_v002 in the dependency graph. At 308, Site A encodes the difference between render_v001 and render_v002 into a delta file in the share directory of the repository. At 310 Site B detects the delta file is ready in its replicated shard of site A and Site B downloads the delta file from site A content server (using any appropriate transport protocol). At 312, Site B reconstructs render_v002 by decoding render_v001 into render_v002 using the delta file.

When a site requests a sync of a remote element version it can also sync all required upstream dependencies using the same delta compression scheme. This removes a considerable part of the complexity posed by sharing creative workloads across sites. Ensuring all required upstream data arrives is an arduous, error prone and manual process in conventional systems. Disclosed implementations greatly simplify this process. Once an element version is transferred from site A to site B and marked as an upstream dependency to a local element, a cross-site dependency is established in the dependency graph. When a new version is generated at site A it is detected and automatically requested by a sync daemon at site B. Users no longer need to manually trigger new transfers.

Each node executes a data sharing service (vrepod) that is configured to serve data in a corresponding repository. The data includes metadata segments corresponding to data segments in a log-structured manner. Each node also executes a client polling service (vsyncd) that polls the data sharing service to gather new records from a last fetched log location of the repository of the first participant node and identify and send a request for a specific data segment that is stored in the repository of the first participant node. In response to the request for the specific data segment the first participant node packs the at least one data segment into an archived format segment based on a similarity index computed across a dependency graph, where the dependency graph includes a cross-node dependency for the data segment between the first participant node and the second participant node. Data is transferred in the archived format from the first participant node to the second participant node.

Cross-node dependencies for the data, between the first participant node and the second participant node, can be recorded in the dependency graph. Transferred data can be data segments that are at least one of a production content data segment and an organizational data segment. Production content data segments can include a corresponding production structure version. The production structures can be at least one of a sequence, a shot, and/or a content element for a media production. The repository of each node can store a shard and a copy of metadata segments stored in repositories of other nodes. Each repository can be an append-only sparse three-dimensional persistent hash map.

All required upstream dependencies of the data segment can be synced and packed into an archived format segment based on a similarity index computed across the dependency graph. Only the bits required to construct a dependent element at target site are transferred. Instead of reconstructing data from a previous version, disclosed implementations use the most similar upstream dependency input, as described with respect to FIG. 2 above.

It will be appreciated that disclosed implementations of the invention may be implemented using a variety of different information processing systems. In particular, although the drawing and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or one or more graphical processing units (GPUs), and/or other hardware arrangements. Method steps implemented in flowcharts contained herein, or as described above, may each be implemented by corresponding respective modules; multiple method steps implemented in flowcharts contained herein, or as described above, may be implemented together by a single module. Various computing devices, such as personal computers, mobile devices, and servers can be used to implement the disclosed computing systems.

It will be appreciated that, insofar as disclosed implementations are implemented by a computer program, then one or more storage media and/or one or more transmission media storing or carrying the computer program form aspects of the invention. The computer program may have one or more program instructions, or program code, which, when executed by one or more processors (or one or more computers), carries out the disclosed function. The terms “program”, “executable”, and “code”, as used herein, may be a sequence of instructions designed for execution on a computer system, and may include a subroutine, a function, a procedure, a module, an object method, an object implementation, an executable application, an applet, a servlet, source code, object code, byte code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc.

Disclosed implementations have several advantages over conventional systems. Because of the decentralized architecture, there is no single point of failure and thus each site can continue work if the network is partitioned or otherwise inhibited. For globally distributed teams metadata latency is reduced to single digit milliseconds. All operations and UX updates are local. The logic and data model for tracking status, dependencies, and synchronization of content data across multiple sites naturally emerge from the properties of the distributed repository design. Further, massive compression ratios are achieved through the properties of the distributed repository design. Disclosed implementations are described in examples relating to a production pipeline. However, the invention is applicable to various content storage and distribution applications.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed:

1. A method for synchronizing data between a plurality of participant nodes in a decentralized content production pipeline network, the method comprising:
executing, by a first participant node of the plurality of participant nodes, a data sharing service (vrepod) that is configured to serve data in a corresponding repository, wherein the data includes metadata segments corresponding to data segments in a log-structured manner;
executing, by a second participant node of the participant nodes, a client polling service (vsyncd) that polls the data sharing service to gather new records from a last fetched log location of the repository of the first participant node and identify and send a request for a specific data segment that is stored in the repository of the first participant node;
in response to the request for the specific data segment, packing, by the first participant node, the at least one data segment into an archived format segment based on a similarity index computed across a dependency graph, where the dependency graph includes a cross-node dependency for the data segment between the first participant node and the second participant node; and
transferring the archived format segment from the first participant node to the second participant node.

2. The method of claim 1, further comprising recording a cross-node dependency for the data segment between the first participant node and the second participant node in the dependency graph.

3. The method of claim 1, wherein the data segments are at least one of a production content data segment and an organizational data segment.

4. The method of claim 3, wherein the production content data segments include a corresponding production structure version.

5. The method of claim 4, wherein the production structures are at least one of a sequence, a shot, and/or a content element for a media production.

6. The method of claim 1, wherein each repository asynchronously replicate DataStore records to other repositories to thereby cause each node to store a shard and a copy of metadata segments stored in repositories of other nodes.

7. The method of claim 6, wherein each repository is an append-only sparse three-dimensional persistent hash map.

8. The method of claim 1, further comprising syncing all required upstream dependencies of the data segment packing the required upstream dependencies into an archived format segment based on a similarity index computed across the dependency graph.

9. A computer system for synchronizing data between a plurality of participant nodes in a decentralized content production pipeline network, the system comprising:
at least one computer processor; and
at least one memory operatively coupled to the at least one computer processor and storing instructions which, when executed by the at least one computer processor, cause the at least one computer processor to:
execute, by a first participant node of the plurality of participant nodes, a data sharing service (vrepod) that is configured to serve data in a corresponding repository, wherein the data includes metadata segments corresponding to data segments in a log-structured manner;
execute, by a second participant node of the participant nodes, a client polling service (vsyncd) that polls the data sharing service to gather new records from a last fetched log location of the repository of the first participant node and identify and send a request for a specific data segment that is stored in the repository of the first participant node;
in response to the request for the specific data segment, pack, by the first participant node, the at least one data segment into an archived format segment based on a similarity index computed across a dependency graph, where the dependency graph includes a cross-node dependency for the data segment between the first participant node and the second participant node; and
transfer the archived format segment from the first participant node to the second participant node.

10. The computer system of claim 9, wherein the instructions further cause the at least one processor to record a cross-node dependency for the data segment between the first participant node and the second participant node in the dependency graph.

11. The computer system of claim 9, wherein the data segments are at least one of a production content data segment and an organizational data segment.

12. The computer system of claim 11, wherein the production content data segments include a corresponding production structure version.

13. The computer system of claim 12, wherein the production structures are at least one of a sequence, a shot, and/or a content element for a media production.

14. The computer system of claim 9, wherein each repository asynchronously replicate DataStore records to other repositories to thereby cause each node to store a shard and a copy of metadata segments stored in repositories of other nodes.

15. The computer system of claim 14, wherein each repository is an append-only sparse three-dimensional persistent hash map.

16. The computer system of claim 9, wherein the instructions further cause the at least one processor to further sync all required upstream dependencies of the data segment packing the required upstream dependencies into an archived format segment based on a similarity index computed across the dependency graph.
